(19) United States
(12) Patent Application Publication
(10) Pub. No.: US 2008/0205432 A1
(43) Pub. Date: Aug. 28, 2008

(54) Network-On-Chip Environment and Method For Reduction of Latency

(75) Inventor: Om Prakash Gangwal, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/910,750

(22) PCT Filed: Apr. 4, 2006
(86) PCT No.: PCT/IB06/51013

§ 371 Date: Oct. 5, 2007

(30) Foreign Application Priority Data
Apr. 7, 2005 (EP) 05102755.5

(51) Int. Cl. H04L 12/43

(52) U.S. Cl. 370/458

(57) ABSTRACT

The invention relates to an integrated circuit comprising a plurality of processing modules (21, 23, M, S; IP) and a network (NoC) arranged for coupling processing modules (21, 23, M, S; IP), comprising: the processing module (21, 23, M, S; IP) includes an associated network interface (NI) which is provided for transmitting data to the network (NoC) supplied by the associated processing module and for receiving data from the network (NoC) destined for the associated processing module; wherein the data transmission between processing modules (21, 23, M, S; IP) operates based on time division multiple access (TDMA) using time slots; each network interface (NI) includes a slot table for storing an allocation of a time slot to a connection (C1-C4), wherein multiple connections (C1-C4) are provided between a first processing module (21, M, IP) and a second processing module (23, S, IP) and a sharing of time slots allocated to these multiple connections between the first and a second processing modules is provided. The invention use the idea to utilize all or a part of time slots in common, which are allocated for multiple connections between a first and a second processing module, in order to reduce the latency of such connections. By sharing of slots assigned to multiple connections between two processing module a large pool of slots during one revolution of a slot table is formed. Thus the latency to access a burst of data could be reduced.

The invention relates to an integrated circuit having a plurality of processing modules and a network arranged for coupling processing modules and a method for time slot allocation in such an integrated circuit, and a data processing system.

Systems on silicon show a continuous increase in complexity due to the ever increasing need for implementing new features and improvements of existing functions. This is enabled by the increasing density with which components can be integrated on an integrated circuit. At the same time the clock speed at which circuits are operated tends to increase too. The higher clock speed in combination with the increased density of components has reduced the area which can operate synchronously within the same clock domain. This has created the need for a modular approach. According to such an approach a processing system comprises a plurality of relatively independent, complex modules. In conventional processing systems the modules usually communicate to each other via a bus. As the number of modules increases however, this way of communication is no longer practical for the following reasons. A large number of modules represent a high bus load. Further the bus represents a communication bottleneck as it enables only one module to send data to the bus.

A communication network forms an effective way to overcome these disadvantages.

Networks on chip (NoC) have received considerable attention recently as a solution to the interconnection problem in highly-complex chips. The reason is twofold. First, NoCs help resolve the electrical problems in new deep-submicron technologies, as they structure and manage global wires. At the same time the NoC concept share wires, allows a reduction of the number of wires and increases the utilization of wires. NoCs can also be energy efficient and reliable and are scalable compared to buses. Second, NoCs also decouple computation from communication, which is essential in managing the design of billion-transistor chips. NoCs achieve this decoupling because they are traditionally designed using protocol stacks, which provide well-defined interfaces separating communication service usage from service implementation.

Introducing networks as on-chip interconnects radically changes the communication when compared to direct interconnects, such as buses or switches. This is because of the multi-hop nature of a network, where communication modules are not directly connected, but are remotely separated by one or more network nodes. This is in contrast with the prevalent existing interconnects (i.e., buses) where modules are directly connected. The implications of this change reside in the arbitration (which must change from centralized to distributed), and in the communication properties (e.g., ordering, or flow control), which must be handled either by an intellectual property block (IP) or by the network.

Most of these topics have been already the subject of research in the field of local and wide area networks (computer networks) and as an interconnect for parallel processor networks. Both are very much related to on-chip networks, and many of the results in those fields are also applicable on chip. However, NoC's premises are different from off-chip networks, and, therefore, most of the network design choices must be reevaluated. On-chip networks have different properties (e.g., tighter link synchronization) and resource constraints (e.g., higher memory cost) leading to different design choices, which ultimately affect the network services. Storage (i.e., memory) and computation resources are relatively more expensive, whereas the number of point-to-point links is larger on chip than off chip. Storage is expensive, because general-purpose on-chip memory, such as RAMs, occupy a large area. Having the memory distributed in the network components in relatively small sizes is even worse, as the overhead area in the memory then becomes dominant.

Off-chip networks typically use packet switching and offer best-effort services. Thus a contention between transmitted data can occur at each network node, making latency guarantees very hard to offer. Throughput guarantees can still be offered using schemes such as rate-based switching or deadline-based packet switching, but with high buffering costs.

An alternative to provide such time-related guarantees is to use time-division multiple access (TDMA) circuits.

A network on chip (NoC) typically consists of a plurality of routers and network interfaces. Routers serve as network nodes and are used to transport data from a source network interface to a destination network interface by routing data on a correct path to the destination on a static basis (i.e., route is predetermined and does not change), or on a dynamic basis (i.e., route can change depending e.g., on the NoC load to avoid hot spots). Routers can also implement time guarantees (e.g., rate-based, deadline-based, or using pipelined circuits in a TDMA fashion). A known example for NoCs is AEthereal.

The network interfaces are connected to processing modules, also called IP blocks, which may represent any kind of data processing unit, a memory, a bridge, a compressor etc. In particular, the network interfaces constitute a communication interface between the processing modules and the network. The interface is usually compatible with the existing bus interfaces. Accordingly, the network interfaces are designed to handle data sequentialization (fitting the offered command, flags, address, and data on a fixed-width (e.g., 32 bits) signal group) and packetization (adding the packet headers and trailers needed internally by the network). The network interfaces may also implement packet scheduling, which may include timing guarantees and admission control.

An NoC provides various services to processing modules to transfer data between them.

The NoC could be operated according to best effort (BE) or guaranteed throughput (GT) services. In best effort (BE) service, there are no guarantees about latency or throughput. Data is forwarded through routers without any reservation of slots. So this kind of data faces contention in the router, whereas giving guarantees is not possible. In contrast, GT service allows deriving exact value for latency and throughput for transmitting data between processing modules.

On-chip systems often require timing guarantees for their interconnect communications. A cost-effective way of providing time-related guarantees (i.e., throughput, latency and jitter) is to use pipelined circuits in a TDMA (Time Division Multiple Access) fashion, which is advantageous as it requires less buffer space compared to rate-based and deadline-based schemes on systems on chip (SoC) which have tight synchronization. Therefore, a class of communication is provided, in which throughput, latency and jitter are guaranteed, based on a notion of global time (i.e., a notion of synchronicity between network components, i.e. routers and network interfaces), wherein the basic time unit is called a slot or time slot. All network components usually comprise a slot table of equal size for each output port of the network component, in which time slots are reserved for different connections. The slot tables advance in synchronization (i.e., all are in the same slot at the same time). The connections are used to identify different traffic classes and associate properties to them. At each slot, a data item is moved from one network component to the next one, i.e. between routers or between a router and a network interface. Therefore, when a slot is reserved at an output port, the next slot must be reserved on the following output port along the path between a master and a slave module, and so on. When multiple connections are set up between several processing modules with timing guarantees, the slot allocation must be performed such that there are no clashes (i.e., there is no slot allocated to more than one connection). The slots must be reserved in such a way that data never has to contend with any other data. It is also called as contention free routing.

The task of finding an optimum slot allocation for a given network topology i.e. a given number of routers and network interfaces, and a set of connections between processing modules is a highly computational-intensive problem as it involves finding an optimal solution which requires exhaustive computation time.

For implementing GT services slot tables are used. The slot tables as mentioned above are stored in the network components, including network interfaces and routers. The slot tables allow a sharing of the same link or wires in a time-division multiple access, TDMA, manner.

An important feature for transmission of data between processing modules is the latency. A general definition of latency in networking could be summarized as the amount of time it takes a data packet to travel from source to destination. Together, latency and bandwidth define the speed and capacity of a network. The latency to access data depends on the size of such a slot table, assignment of slots for a given connection in the table and the burst size. The burst size is the amount of data that can be asked/sent in one request. When the number of slots allocated for a connection between two processing modules is less than the number of slots required to transfer a burst of data the latency to access data increases dramatically. In such case more than one revolution of the slot table is needed to completely send a burst of data. The waiting time for the slots that are not allocated to this connection is also added to the latency.

A second feature as mentioned above is the bandwidth. A connection between processing modules has a predetermined bandwidth. It is possible to have more than one connection between two processing modules having different bandwidths. In such a system, where two processing modules have multiple connections of varying bandwidth requirements between them for communicating, the connection with lowest throughput has the highest latency for a given burst to complete. Sometimes this high latency for low throughput connection is not acceptable. E.g. an audio stream needs 200 Kbytes/sec, a transmission of a video stream requires 20 Mbytes/sec. An increased latency on a low throughput connection e.g. may result in an undesirable quality output.

A first approach to reduce the latency is to allocate unallocated slots. However under certain conditions the number of unallocated slots may be very low, so this approach provides no reduction of latency for low throughput connections.

Therefore it is an object of the present invention to provide an arrangement and a method having an improved slot allocation in a Network on Chip environment.

This object is solved by an integrated circuit according to claim 1 and a method for time slot allocation according to claim 9.

It is proposed to share at least a part of the time slots allocated to multiple connections between a first and a second processing module to reduce the latency to transfer a burst of data. The invention use the idea to utilize the shared slots in common, which are allocated for multiple connections between a first and a second processing module, in order to reduce the latency of such connections. The inventive sharing of slots resumes multiple connections between two processing modules. That means the source processing module and the destination processing module needs to be the same for the multiple connections.

By sharing of slots assigned to multiple connections between two processing modules a large pool of slots during one revolution of a slot table is formed. Thus the latency to access a burst of data could be reduced. The sharing of slots is performed in such a manner that throughput allocated to each connection remains the same. By using the shared slots it is possible to transmit a burst of data having normally a low throughput connection during fewer slot table revolutions. This will result in a decreased signaling effort, since there is only one header needed instead of several headers attached to each part of the burst. Since a header covers bandwidth also, this bandwidth could be saved.

However one of the main advantages is that by using the inventive method and integrated circuit a control of latency is possible. So the user can influence the latency.

Other aspects and advantages of the invention are defined in the dependent claims.

In a first preferred embodiment of the invention the transmission of data is performed based on contention free transmission based on peer-to peer connection. A connection could have several properties and comprises at least one channel for transporting time slots allocated to a connection. By use of connection guarantees could be provided.

In a further preferred embodiment of the invention all slots allocated to multiple connections are shared.

In a further preferred embodiment of the invention the shared slots of the multiple connections are combined in a pool and all shared slots in the pool are used in common for data transmission over the multiple connections between the two participating processing modules. Since the amount of slots available for allocation is increased, the latency will be reduced. Under normal circumstances a connection is not completely used. So there are situations, in which not each of the multiple connections are used for transmitting data. By pooling the slots of all or a part of the multiple connections between two processing modules the capacity of the unused connections is used by the busy connections. This will reduce the latency for the most connections. Only for connections of the multiple connections having a large number of slots allocated there may be an increase of latency in worst case. However in average the latency stays the same for each connection within the multiple connections between the two processing modules.

In a further predetermined embodiment of the invention there is a pool scheduler provided. The pool scheduler is included in the network interface. The pool scheduler controls the transmission of data between the first and second processing modules using the multiple connections. By choosing the kind of control of the data transmission of the multiple connections the latency could by controlled. The pool scheduler decides depending on its controlling or arbitration scheme which data of the multiple connections are transmitted first. In particular when all queues of the connections are filled with data the pool scheduler decides or arbitrates which queue is served first.

In a further predetermined embodiment of the invention a budget will be allocated to each of the multiple connections. In particular the budget is allocated for predetermined time. So it could by defined in which time period, e.g. how many revolutions of the slot table, a burst of data should transmitted. Note that budgeting is used to maintain throughput guarantees as promised by simple slot scheduler without pooling. The transmission of data between the first and the second processing modules over the multiple connections is performed in dependency of the allocated budget. If a connection has used its allocated budget it will not be served further within the budgeting period. This budgeting is stored in a pool table, wherein the pool scheduler accesses the information within the pool table to arbitrate which connection is served first. When more than one connection within a pool have data ready to be sent and some budget is also left unused then an arbitration scheme is used to resolve the requests. There are two examples of arbitration, round robin and priority based. The technique where each request is scheduled in turn by turn basis, e.g. in a certain order such that it is fair to all requesters, is called round robin arbitration. In priority based arbitration, each request has some priority (higher/lower), when multiple requests are present the request with highest priority is selected. This priority may be also stored in the pool table. The pool scheduler decides depending on the priority which data of the multiple connections is transmitted first. In one example it may be practical to allocate connections having the fewest number of slots allocated in the conventional scheme the highest priority. This allows the transmission of data by using the large number of pooled slots at once. So a data burst of this connection is transmitted during one revolution of the slot table. During configuring the NoC the priorities for certain connections could be defined. This provides a further possibility to control the latency.

In a further embodiment it is possible that the first processing module includes a first set of multiple connections with a second processing module and a second set of multiple connections with a third processing module. Also in that case the slots of the second set of multiple connections are shared in second pool. To handle the scheduling of data transmission to the third multiple connections a further pool scheduler is provided in the network interface associated to the first processing module for controlling the transmission of data between the first and third processing module.

The invention also relates to a method for allocating time slots for data transmission in a integrated circuit having a plurality of processing modules and a network arranged for coupling the processing modules and a plurality of network interfaces each being coupled between one of the processing modules and the network comprising the steps of: communicating between processing modules based on time division multiple access using time slots; storing a slot table in each network interface including an allocation of a time slot to a connection, providing multiple connections between a first and a second processing module; sharing of at least a part of time slots allocated to these multiple connections between the first and a second processing module.

The invention further relates to a data processing system comprising: a plurality of processing modules and a network arranged for coupling the processing modules, a network interface associated to the processing module which is provided for transmitting data to the network supplied by the associated processing module and for receiving data from the network destined for the associated processing module; wherein the data transmission between processing modules is based on time division multiple access using time slots; each network interface includes a slot table for storing an allocation of a time slot to a connection, wherein multiple connections are provided between a first processing module and a second processing module and a sharing of at least a part of time slots allocated to these multiple connections between the first and a second processing modules is provided.

Accordingly, the time slot allocation may also be performed in a multi-chip network or a system or network with several separate integrated circuits.

Preferred embodiments of the invention are described in detail below, by way of example only, with reference to the following schematic drawings.

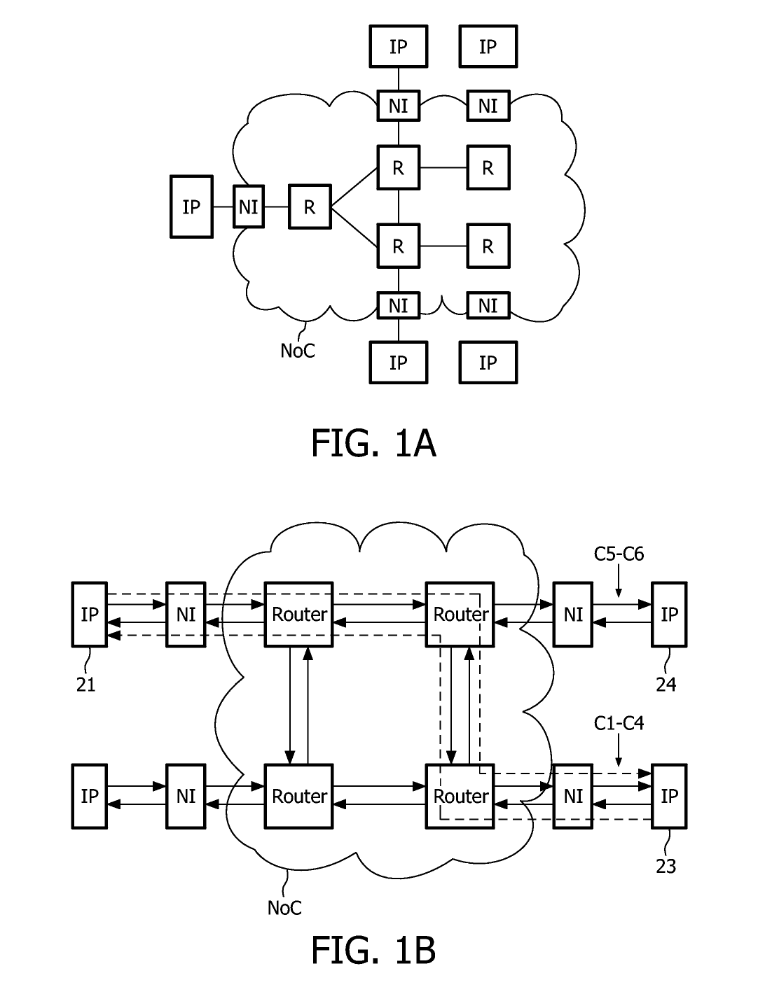

FIG. 1A shows the basic structure of a network on chip according to the invention;

FIG. 1B shows the transmission of data between two IP blocks through a NoC;

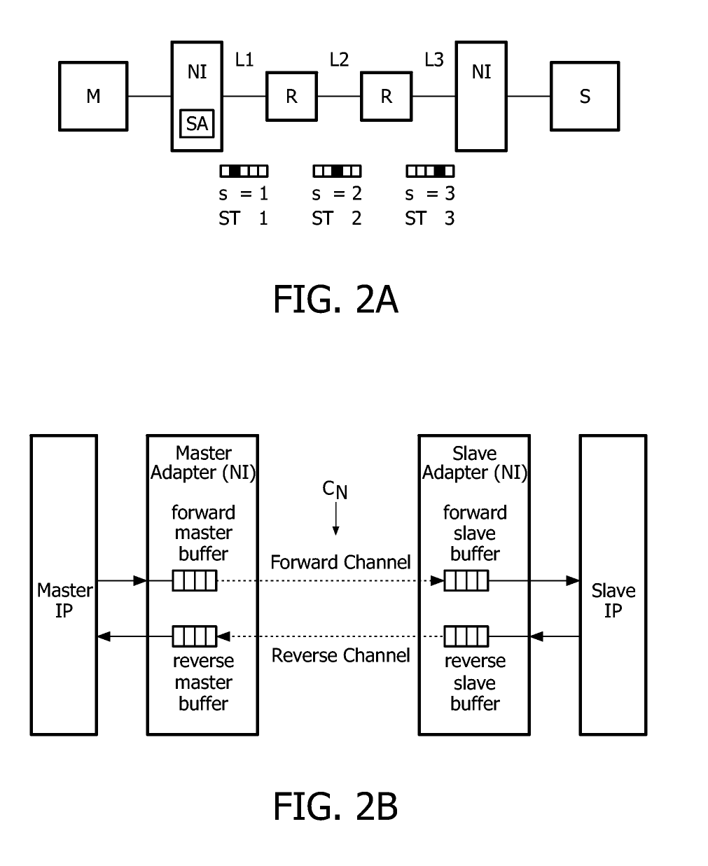

FIG. 2A shows a basic slot allocation for a connection in a NoC;

FIG. 2B shows a connection between a master and slave;

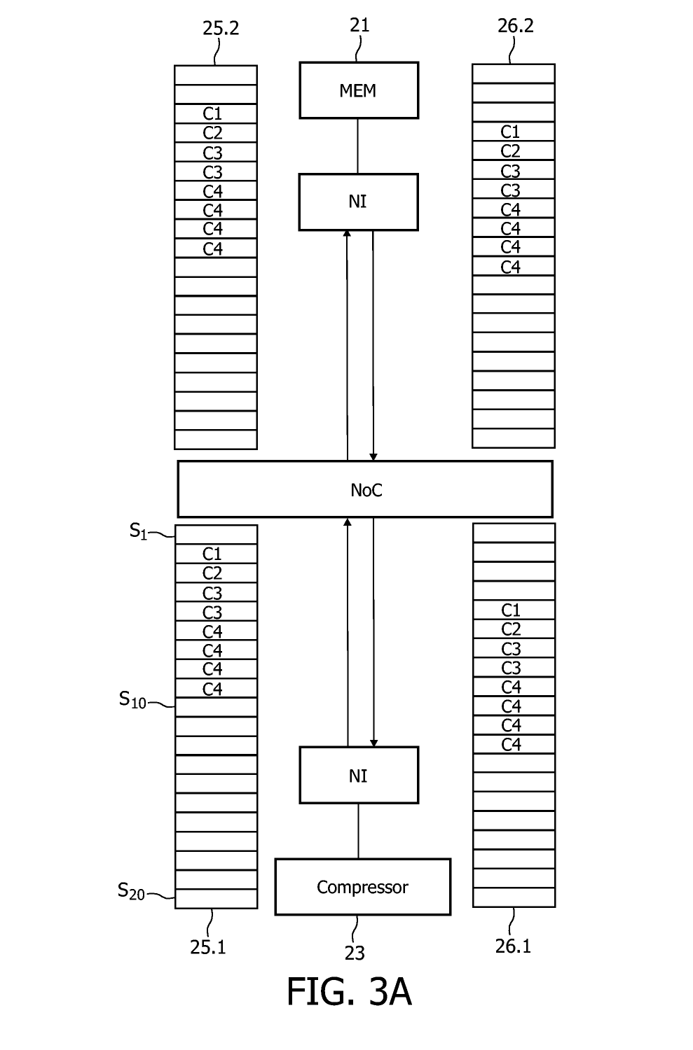

FIG. 3A shows a schematic illustration of the slot allocation between two IP blocks according to the prior art;

FIG. 3B shows an exemplary shared slot allocation according to the present invention;

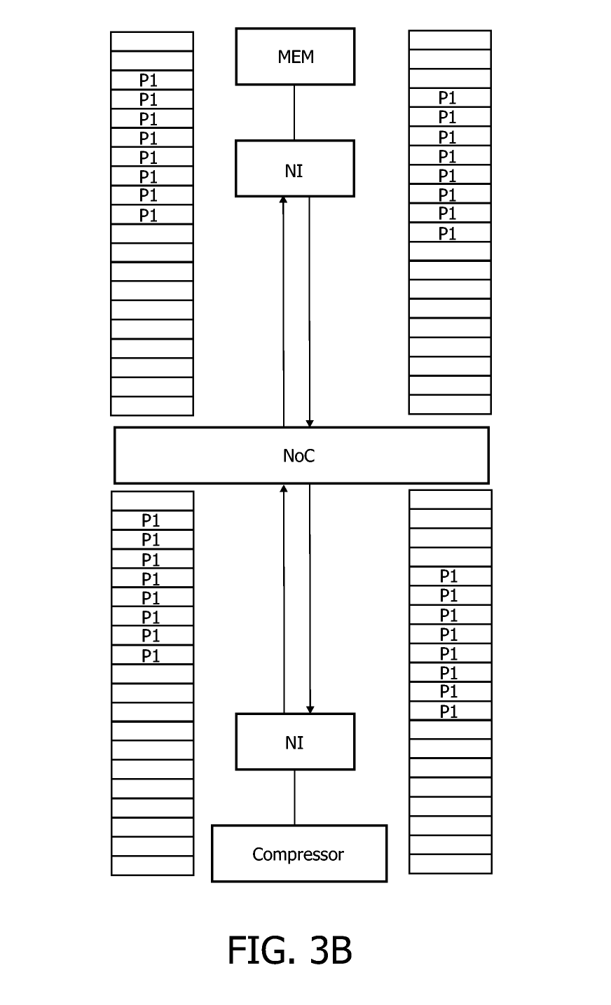

FIG. 4 illustrates a network interface having a pool scheduler according to the present invention;

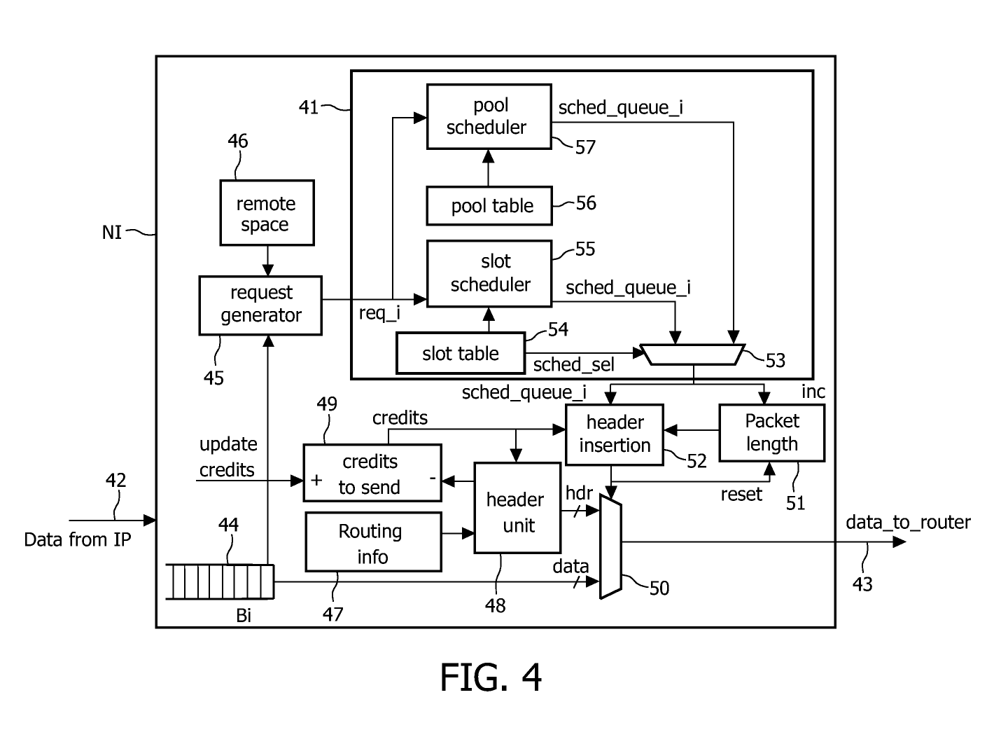

FIG. 5 shows a sequence of slots according to the present invention;

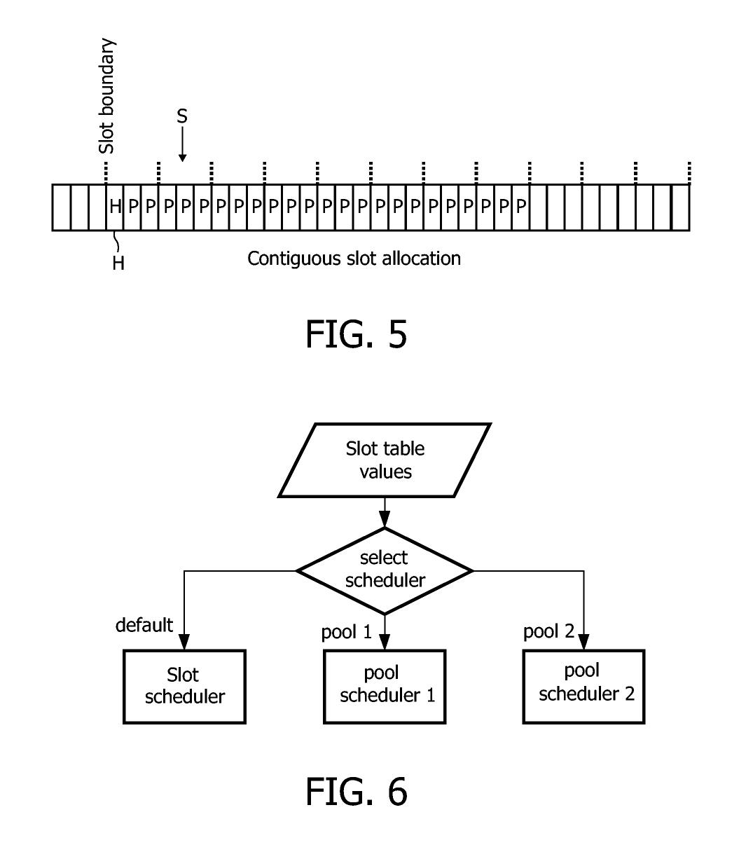

FIG. 6 illustrates a flow chart of the selection of a scheduler;

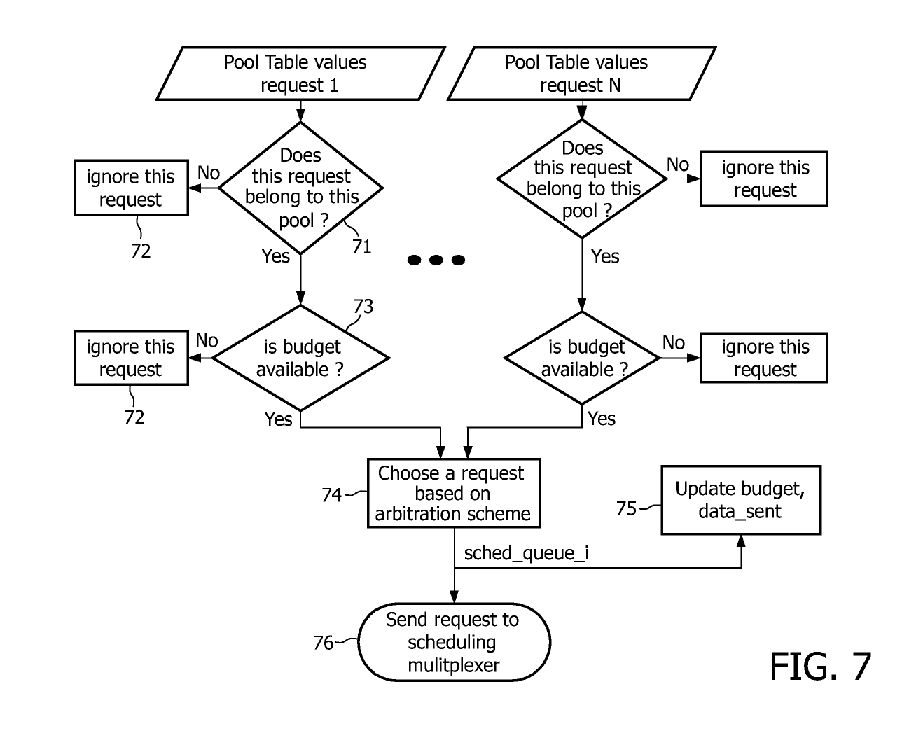

FIG. 7 illustrates a flow chart for selecting a queue or connection;

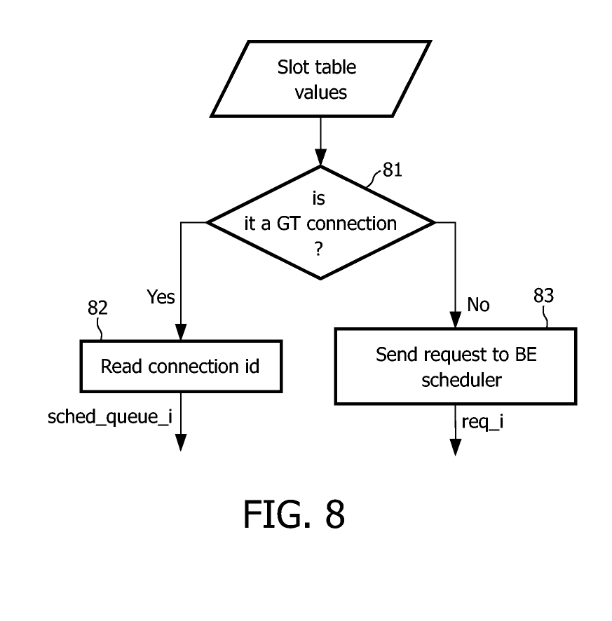

FIG. 8 illustrates a flow chart for selecting the kind of service.

The drawings are provided for illustrative purpose only and do not necessarily represent practical examples of the present invention to scale.

In the following the various exemplary embodiments of the invention are described.

Although the present invention is applicable in a broad variety of applications it will be described with the focus put on NoC, especially to AEthereal design. A further field for applying the invention might each NoC providing guaranteed services by using time slots and slot tables.

In the following the general architecture of a NoC will be described referring to FIGS. 1A, 1B, 2A and 2B.

The embodiments relate to systems on chip SoC, i.e. a plurality of processing modules on the same chip communicate with each other via some kind of interconnect. The interconnect is embodied as a network on chip NoC. The network on chip NoC may include wires, bus, time-division multiplexing, switch, and/or routers within a network.

FIG. 1A and 1B show examples for an integrated circuit having a network on chip according to the present invention. The system comprises several processing modules, also called intellectual property blocks IPs. The processing modules IP could be realized as computation elements, memories or a subsystem which may internally contain interconnect modules. The processing modules IP are each connected to a network NoC via a network interface NI, respectively. The network NoC comprises a plurality of routers R, which are connected to adjacent routers R via respective links L1, L2, L3. The network interfaces NI are used as interfaces between the processing modules IP and the network NoC. The network interfaces NI are provided to manage the communication of the respective processing modules IP and the network NoC, so that the processing modules IP can perform their dedicated operation without having to deal with the communication with the network NoC or other processing modules IP. The processing modules IP may act as masters M, i.e. initiating a request, or may act as slaves S, i.e. receiving a request from a master M and processing the request accordingly.

At the transport layer of said network NoC, the communication between the processing modules IP is performed over connections C_{N}. A connection C_{N} is considered as a set of channels, each having a set of connection properties, between a first processing module IP and at least one second processing module IP. For a connection between a first processing module IP and a single second processing module IP, the connection may comprises two channels, namely one from the first to the second processing module, i.e. the request or forward channel, and a second channel from the second to the first processing module, i.e. the response or reverse channel as illustrated in FIG. 2B. The forward or request channel is reserved for data and messages from the master IP to the slave IP, while the reverse or response channel is reserved for data and messages from the slave IP to the master IP. If no response is required, the connection may only comprise one channel. It is not illustrated but possible, that the connection involves one master IP and N slaves IP. In that case 2*N channels are provided. Therefore, a connection C_{N} or the path of the connection through the network comprises at least one channel. In other words, a channel corresponds to the connection path of the connection if only one channel is used. If two channels are used as mentioned above, one channel will provide the connection path e.g. from the master IP to the slave IP, while the second channel will provide the connection path from the slave IP to the master IP. Accordingly, for a typical connection C_{N}, the connection path will comprise two channels. The connection properties may include ordering (data transport in order), flow control (a remote buffer is reserved for a connection, and a data producer will be allowed to send data only when it is guaranteed that space is available for the produced data), throughput (a lower bound on throughput is guaranteed), latency (upper bound for latency is guaranteed), the lossiness (dropping of data), transmission termination, transaction completion, data correctness, priority, or data delivery.

FIG. 2A shows a block diagram of a single connection and a respective basic slot allocation in a network on chip. To simplify explanation only one channel (e.g. the forward channel) of the connection is shown. In particular, the connection between a master M and a slave S is shown. This connection is realized by a network interface NI associated to the master M, two routers, and a network interface NI associated to a slave S. The network interface NI associated to the master M comprises a time slot allocation unit SA. Alternatively, the network interface NI associated to the slave S may also comprise a time slot allocation unit SA. A first link L1 is present between the network interface NI associated to the master M and a first router R, a second link L2 is present between the two routers R, and a third link L3 is present between a router and the network interface NI associated to the slave S. Three slot tables ST1-ST3 for the output ports of the respective network components are also shown. These slot tables are preferably implemented on the output side, i.e. the data producing side, of the channel of the network elements like network interfaces and routers. For each requested slot, one slot is reserved in each slot table of the links along the connection path. All these slots must be free, i.e., not reserved by other channels. Since the data advance from one network component to another each slot, starting from slot s=1, the next slot along the connection must be reserved at slot s=2 and then at slot s=3.

The inputs for the slot allocation determination performed by the time slot allocation unit SA are the network topology, like network components, with their interconnection, and the slot table size, and the connection set. For every connection, its paths and its bandwidth, latency, jitter, and/or slot requirements are given. A connection consists of at least two channels or connection paths. Each of these channels is set on an individual path, and may comprise different links having different bandwidth, latency, jitter, and/or slot requirements. To provide time related guarantees, slots must be reserved for the links. Different slots can be reserved for different connections by means of TDMA. Data for a connection is then transferred over consecutive links along the connection in consecutive slots.

In the following the present invention will be explained in more detail. FIG. 3A illustrates a simplified section of an integrated circuit including a NoC according to the prior art. There are two processing modules 21 and 23. The one processing module 21 is realized as memory for storing data. The second processing module 23 is a compressor for compressing or coding of data. The processing modules 21, 23 each include a network interface NI. The network interfaces NI include the slot allocation table 25.1, 26.2 showing the slot allocation for the forward and the reverse channel for four connections C1, C2, C3, C4. There is only one slot table 25.1, 26.2 present for each channel. The illustrations 25.2 and 26.1 shows slot allocation at the receiving side for both channels for the connections C1-C4. The compressor 23 requests a data transmission from the memory 21. As mentioned above in respect to FIG. 2A the memory 21 may act as slave and as master. If the memory 21 is acting as slave it receives data from the compressor 23 by use of the four different connections C1-C4. A first slot allocation table 25.1 is required at the output side on the NI of compressor 23, wherein the slots are shifted by one as illustrated at the receiving side 25.2 in the memory 21. In the reverse direction the memory 21 transmits data to the compressor 23 using slot allocation table 26.2. Therein the slots are further shifted by one slot. As shown at receiving side in the compressor 23 in illustration 26.1 the slots for the connections C1-C4 are postponed by one slot. Each of the connection C1-C4 between the two processing modules 21, 23 has a number of slots allocated. Connections C1 and C2 have only one slot allocated each. Therefore they are designated as low throughput connections. Connection C3 has two slots allocated in the slot tables 25.1, 26.2. Connections C4 has four slots allocated. So there are multiple connections C1-C4 between these two processing modules 21, 23 having throughput requirements.

The slot table size is 20. A slot has three words (a word is for example 32 bits), where the first word can be used to send header H that may consist of network specific information, e.g. path. If it is assumed that two words of data can be transferred by use of one slot then transferring a burst of 16 words would require 8 slots.

The latency to transfer a burst of 16 units of data or words for each connection is shown in table 1. The table 1 shows that the maximum latency to transfer the burst of 16 words is 8 revolutions or 160 flit or slot cycle for the connections C1 and C2. Such high latency may not be acceptable to processing module. For instance an audio decoder or an audio sample rate converter may require low latencies.

TABLE 1
Latency to transfer a burst of 16 units of data

| | | # of words | | Latency |
|---|---|---|---|---|
| | Number | that can be | # of revolutions | to transfer the |
| | of slots | sent in one | to complete the | burst (in terms |
| Connection | allocated | revolution | burst of 16 units | of flit cycles) |
| C1 | 1 | 2 | 8 | 8 × 20 = 160 |
| C2 | 1 | 2 | 8 | 8 × 20 = 160 |
| C3 | 2 | 4 | 4 | 4 × 20 = 80 |
| C4 | 4 | 8 | 2 | 2 × 20 = 40 |

A word is a unit of data. The slot table e.g. 25.1 includes further slots S1, S10-S20 allocated to other connections between the respective processing module 21 and other processing modules IP as shown in FIG. 1A or 1b. The same applies for the slot tables, 26.2 respectively, wherein the position of the slots is shifted by two slots.

The high latency for the low throughput connections C1 and C2 could not be accepted. Given a NoC is running at 500 MHz, this means 2 ns per cycle, as one slot/flit has three words it requires 3 cycles, i.e., 6 ns. 160 flits is 160×6 ns=960 ns. The latency to transfer data for a given burst size strongly depends on the number of slots allocated for the given connection. Therefore, the low throughput connections C1 and C2 suffer from high latency.

This is a general problem with TDMA based schemes. To solve this problem the invention proposes to reduce the latency by sharing the slots allocated for multiple connections between two processing module 21, 23. Sharing the slots of multiple connections between two processing module 21, 23 provides an increased amount of slots for data transmission. There will be a large pool P1 of slots during one revolution of a slot table and thus the latency to access a burst is reduced.

The proposed invention will now be explained in more detail in respect to FIG. 3B and FIG. 4. The sharing is performed in such a manner that throughput allocated to each connection remains the same to keep the guarantees for throughput and a better control on the latency is achieved.

As can be seen in FIG. 3B the slots allocated to connections between the two processing modules 21 and 23 are designated with P1.

This is achieved by a kind of budgeting scheme to control over/under utilization of shared slots among connections within a specified time. This keeps the guaranteed throughput property of a connection.

As mentioned above many scheduling strategies, e.g., round robin, priorities, can be used to control latency for each connection in the pool.

A circuit for budgeting and arbitration among the pool P1 of connections is needed to achieve the results. For guarantee data throughput, a supply of at least a complete burst of data is needed, actually that is natural for a bursty traffic.

Table 2 illustrates the effect of using a predetermined time budget of 8 revolutions. It

also illustrates the use of round robin and an example priority arbitration mechanism.

TABLE 2
Latency to transfer a burst of 16 units data with sharing of slots.

| | | latency when 8 slots are shared for | | | |
|---|---|---|---|---|---|
| | | 8 revolutions using the following | | | |
| | | arbitration scheme | | | |
| | | | | Priority of (1, 1, 2, 3) | |
| | # of bursts | Round robin | | where 1 is high priority | |
| Connec- | that can be sent | Worst | Average | Worst | Average |
| tion | in 8 revolutions | case | case | case | case |
| C1 | 1 | 4 × 20 | 4 × 20 | 2 × 20 | 1.5 × 20 |
| C2 | 1 | 4 × 20 | 4 × 20 | 2 × 20 | 1.5 × 20 |
| C3 | 2 | 4 × 20 | 4 × 20 | 3 × 20 | 3.5 × 20 |
| C4 | 4 | 4 × 20 | 2 × 20 | 5 × 20 | 2 × 20 |

Table 2 shows that the maximum latency for any connection C1-C4 has been reduced from 8 revolutions to 4 revolutions in case of round robin arbitration scheme and to 5 revolutions in case of an example priority scheme. For low throughput connections C1 and C2 the worst latency is reduced by a factor of 2 to 4. For a high throughput connection C4 the worst latency increases from 2 revolutions to 4 revolutions in case of round robin and to 5 in case of priority arbitration.

For round robin arbitration each request is scheduled in turn by turn basis, e.g. in a certain order such that it is fair to all requesting queues, is called round robin arbitration. Fairness means before serving the same request again all other requests are considered. IT will be explained on short example: N requests are present and a grant cyclic order from 1-N is assumed. Assume all requests are present, then request N can be served only after all the requests before N (i.e. 1 to N−1) has been served. This provides an upper bound on latency to serve a request and that is N−1.

Table 2 shows that for 4 connections, round robin arbitration results in 4 revolution of slot table to send. This time includes the worst case waiting time of 3 (4−1) slot table revolutions of slot table to serve 3 requests and time of 1 slot table revolution is needed to serve the current request.

But the important thing to note is that the latency is still bounded or limited and average latency over budgeting period is the same as before i.e. 2 revolutions. The importance of technique according to the present invention is that it allows control over latency of a given connection.

The technique presented in this invention requires a procedure to relate various different connections to a shared pool of slots. This can be implemented by means of a pool table 56. Such pool table 56 may be instantiated per pool P1 in the network interface NI.

An exemplary pool table 56 is shown in table 3.

TABLE 3
Details of connections of a pool with
budget of 8 revolutions (e.g. Pool P1)

| Connection ID | Burst Size | Budget | Priority |
|---|---|---|---|
| C1 | 16 | 1 | 1 |
| C2 | 16 | 1 | 1 |
| C3 | 16 | 2 | 2 |
| C4 | 16 | 4 | 3 |

The arbitration mechanism can be implemented as part of the scheduler 41 in network interface NI. A pool scheduler 46 performs the arbitration.

Furthermore, to identify the relation of a burst to a connection, information sent in the header of a packet (e.g. remote connection/queue ID) should be derived based on the results of arbitration.

In the following the pseudo code of a scheduler 41 providing GT service for connections participating in a pool is explained:

Pseudo code of GT_scheduler including pool scheduling

GT_scheduler( )
{

// for each flit cycle do the following
switch(sel){
case cur_slot is part of a pool1:

pool scheduler1;

break;
case cur_slot is part of a pool2:

pool scheduler2;

break;
default:

slot scheduler;

break;
}

}

An illustration of that code could be found in FIG. 6.
Scheduling for connections participating in a pool is explained below:

connection // additional information needed for a connection
{

id; // connection identifier
burst_size; // burst size for the given connection
budget; // allocated budget within the pool
priority; // optional priority if priority based
arbitration/scheduling is used

}
cur_connection [Num_pools]; // current connection of type connection
data_sent [Num_pools]; // data sent till now for cur_connection
sched_queue _i pool_scheduler1(req_i)
{

if (cur_slot is part of the pool)
{

// administration to keep the throughput distribution the same
data_sent[cur_slot]++;
if (data_sent[cur slot] == cur_connection[cur_slot].burst_size)
{

cur_connection[cur_slot].budget--;
data_sent[cur_slot] = 0;
cur_connection[cur_slot] =
ChooseNewConnection(req_i);

}

}

}

An illustration of that code could be found in FIG. 7.

sched_queue_i ChoosNewConnection(req_i)

{

the behavior of this function depends on the chosen
arbitration/scheduling scheme e.g.round robin, priority
based etc.

}

An illustration of that code could be found in FIG. 8.

FIG. 4 illustrates the components of a network interface NI. However, only the transmitting direction of the NI is illustrated. The part for receiving data packets is not illustrated. The network interface NI comprises flow control means including an input queue Bi, a remote space register 46, a request generator 45, a routing information register 47, a credit counter 49, a slot table 54, a slot scheduler 55, a pool table 56, a pool scheduler 57, a scheduling multiplexer 53, a header unit 48, a header insertion unit 52 as well as a packet length unit 51 and an output multiplexer 50.

The NI receives the data at its input port 42 from the transmitting processing module 21, 23. The NI outputs the packaged data at its output 43 to the router in form of a data sequence as exemplary shown in FIG. 5. The data belonging to a connection are supplied to a queue Bi 44. Due to the sake of clarity only one queue 44 is illustrated. However each data belonging to a certain connection C1-C_{N} will be inputted in a single queue Bi associated to only one connection. That means there will be as much queues i as connections C1-C_{N} are used by the processing module IP. The first data in the queues are monitored by the request generator 45. The request generator 45 detects the kind of data service which needs to be used. The request generator 45 generates the request req_i for the queue Bi to send data based on the queue filling and the available remote space as stored in the remote space register 46. The requests req_i for all queues i are provided to the pool scheduler 57 and to the slot scheduler 55 for selecting the next queue. This can be performed by the slot scheduler 55 based on information from the slot table 54 and by the pool scheduler 57 based on information from the pool table 56. The pool scheduler 57 detects whether the data belongs to a connection C1-C4 having shared slots. The slot scheduler 55 detects requests req_i belonging to data which are not part of shared pool P1 of slots. As soon as one of the queues is selected in one of the schedulers 55, 57 it is provided to the scheduling multiplexer 53. The multiplexing is based on the slot allocation table 54. Depending on the slot position in the slot allocation table 54 a scheduled queue sched_queue_i is scheduled by the schedul_sel command and outputted by the scheduling multiplexer 53. After being outputted by the scheduling multiplexer 53 the header insertion unit 52 decides whether an additional redundant header H needs to be inserted. A header H is inserted if the current slot is the first in a succession as a header is required. A redundant or extra header H is inserted if a condition for an extra header insertion is met. Such a condition may be if the packet length and/or the credits to be sent are above a threshold value.

The characteristic of multiple connections C1-C4 is stored in a pool table 56. An exemplary pool table is shown in table 3 above. Depending on the scheduling scheme used in the pool scheduler 57 (budget, round robin and/or priority) the data in the queues are scheduled. Therein the data having the largest budget are scheduled first. If the pool scheduler 57 operates on the priorities the data having the highest priorities are scheduled at first. Data not belonging to one of the multiple connections between two processing modules 21, 23 are normally scheduled by the slot scheduler 55.

The multiplexer 53 forwards the scheduled queue/connection id (sched_queue_i) to the header insertion 52 and to a unit 51 which increments the packet lengths. Routing information like the addresses is stored in a configurable routing information register 47. The credit counter 49 is incremented when data is consumed in the output queue and is decremented when new headers H are sent with credit value incorporated in the headers H. The routing information from the routing information register 47 as well as the value of the credit counter 49 is forwarded to the header unit 48 and form part of the header H. The header unit 48 receives the credit value and routing info and outputs the header data to the output multiplexer 50. The output multiplexer 50 multiplexes the data provided by the selected queue and the header info hdr provided from the header unit 48. When a data package is sent out the packet length is reset.

For illustrating a simple example a plurality of pool scheduler is omitted. However a processing module could have a plurality of multiple connections to different processing modules. So it is possible that there are four connections C1-C4 between processing modules 21 and 23. Further there could be a second set of multiple connections C5-C6 from processing module 21 to a third processing module 24 as illustrated in FIG. 1B. In such case there is a further pool scheduler detecting and scheduling data provided for the connections C5-C6 to the third processing module 24.

This arbitration or scheduling mechanism incorporated in the pool scheduler 57 increases the complexity of the control of the network interface NI but on the other hand the present invention provides a reduction of latency for transferring data. Further it provides a control over latency of connections in a given system. The programming of the pool table 56 and the scheduling scheme used in the pool scheduler 57 is even possible after the fabrication of the chip. The latency of various connections is distributed more evenly, providing advantage to match with specified IP latency easily.

If allocated slots S₁-S_{N} for the multiple connections C1-C4 are contiguous as shown in FIG. 5 the average amount of data or payload P that can be sent in one slot S_{N} increases as there will be less headers H sent. As shown in FIG. 5 there is one header H in front of the pooled slots S_{N} only. So if a data burst is sent using the shared slots at once only one word or data unit of the data sequence is used for the header H. All other data units in the slots are used for scheduling payload data—so only one header H is required. If this burst would be transmitted without using shared slots it would take more than one revolution of a slot table until the whole amount of data will be transmitted completely. Additionally each time a connection gets a slot allocated a new header must be coupled to the data requiring valuable bandwidth.

Note that in GT service a header is sent for all slots for which the previous slot is not allocated for the connection. In fact, this may also lead to further latency reduction as number of revolutions required to send a burst reduces.

In the following the pseudo code mentioned above will be explained in more detail referring to the FIGS. 6-8.

FIG. 6 illustrates the selection process at the scheduling multiplexer 53 in FIG. 4. The queues which are scheduled by the slot scheduler 55 or the pool scheduler 57 are provided to the scheduling multiplexer 53. Depending on the slot table values stored in the slot table 54 a scheduled queue/connection id is selected in the scheduling multiplexer 53. The slot table values includes the queue/connection Id and the scheduler type. Depending on the scheduler type the respective queue/connection Id is chosen or selected. In the example shown in FIG. 6 a further pool scheduler 2 is included. So FIG. 6 shows components of a network interface NI necessary for handling two sets of multiple connections as shown in FIG. 1b. The connections C5-C6 are controlled by the second pool scheduler 2.

FIG. 7 represents the arbitration mechanism as performed by the pool scheduler 57. IN the flow chart the process for only one pool scheduler 57 is illustrated. There is a plurality of vertical flows belonging to a plurality of request 1-N, wherein each flow represents the procedure for one request req_i. In the first decision 71 it is determined by the pool scheduler 57, whether the request req_i belongs to its pool. If not the request is ignored 72. If yes it is checked in step 73 whether budget is available for the respective connection. The budget is stored in the pool table 56. If there is budget for the connection left the pool scheduler will arbitrate the request depending from the used arbitration scheme. A possible scheme for arbitrate several requests is round robin, which give each request a fair chance to be handled within a predetermined time. The arbitration scheme could also use priorities allocated to connections, wherein the connection having the highest priority are served first. After arbitrating in step 74 the selected request is sent to scheduling multiplexer 53 in step 76. Further the budget and burst values are updated in step 75.

FIG. 8 illustrates the determination whether the request belongs to GT or BE services. Based on the slot table value stored in the slot table 54 the decision is felt in step 81, whether the request under consideration requires guaranteed throughput services or best effort services. In case of GT services the connection Id number is derived (82) from the slot table 54. If the request requires best effort BE services (83) the request is forwarded to the best effort scheduler. The network interface NI as presented in FIG. 4 does not show a best effort scheduler.

So the invention enables to reduce the latency for multiple connections between two processing modules. The only disadvantage is a slight increase of the complexity of control part of network interface.

The invention is explained in the context of multiple synchronized TDMA however it is also applicable for single TDMA systems. In general it is applicable to interconnect structures basing on connections and providing guarantees.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. In the device claim enumerating several means, several of these means can be embodied by one and the same item of hardware. The mere fact that certain measures are recited in mutually different dependent claims does not indicate that a combination of these measures cannot be used to advantage. Furthermore, any reference signs in the claims shall not be construed as limiting the scope of the claims.

1. Integrated circuit comprising a plurality of processing modules (21, 23, M, S; IP) and a network (NoC) arranged for coupling said processing modules (21, 23, M, S; IP),
wherein the processing module (21, 23, M, S; IP) includes an associated network interface (NI) which is provided for transmitting data to the network (NoC) and for receiving data from the network (NoC);
wherein data transmission between processing modules (21, 23, M, S; IP) is based on time division multiple access using time slots (S₁-S₂₀);
wherein each network interface (NI) includes a slot table for storing an allocation of a time slot to a connection (C1-C4), and
wherein multiple connections (C1-C4) are provided between a first processing module (21, M, IP) and a second processing module (23, S, IP) and a sharing of at least a part of time slots allocated to these multiple connections between the first and a second processing modules is provided.

2. Integrated circuit as claimed in claim 1, wherein the data transmission between processing modules (21, 23, M, S; IP) is based a contention free transmission by using connections (C1-C4).

3. Integrated circuit as claimed in claim 1, wherein the all time slots allocated to multiple connections between the first and a second processing modules (21, 23, M, S; IP) are shared.

4. Integrated circuit as claimed in claim 1, wherein the shared slots of the multiple connections (C1-C4) are combined in a pool (P1) and all shared slots in the pool (P1) are used in common for data transmission of the multiple connections (C1-C4).

5. Integrated circuit as claimed in claim 1, including a pool scheduler (57) included in the network interface (NI), the pool scheduler (57) is provided for controlling the transmission of data between the first and second processing modules using the multiple connections (C1-C4).

6. Integrated circuit as claimed in claim 1, wherein a budget within a predetermined time and/or a priority is allocated to each connection (C1-C4) of the multiple connections (C1-C4) and the transmission of data between the first and the second processing modules over the multiple connections (C1-C4) is performed in dependency of the allocated budget and/or priority.

7. Integrated circuit as claimed in claim 1, wherein the pool scheduler is provided for performing an arbitration of multiple requests of the connections (C1-C4), wherein the arbitration is performed based on round robin or priorities given to the multiple connections (C1-C4).

8. Integrated circuit as claimed in claim 1, wherein a second set of multiple connections (C5-C6) exist between the first processing module (21) and a third processing module (24), wherein a sharing of at least a part of time slots is provided, which are allocated to the second set of multiple connections (C5-C6) between the first and the third processing module and a second pool scheduler is provided in the network interface (NI) associated to the first processing module for controlling the transmission of data between the first and third processing module (21, 24).

9. Method for allocating time slots for data transmission in an integrated circuit having a plurality of processing modules (21, 23, M, S; IP) with a network interface (NI) and a network (NoC), the method comprising the steps of:
communicating between processing modules (21, 23, M, S; IP) based on time division multiple access using time slots (S₁-S₂₀);
storing a slot table (54) in each network interface (NI) including an allocation of a time slot to a connection (C_{N}),
providing multiple connections (C1-C4) between a first processing module (21, M, IP) and a second processing module (23, S, IP); and
sharing of at least a part of time slots allocated to the multiple connections (C1-C4) between the first and a second processing modules (21, 23, M, S; IP).

10. Data processing system comprising:
a plurality of processing modules (21, 23, M, S; IP) and a network (NoC) arranged for coupling the processing modules (21, 23, M, S; IP); and
a network interface (NI) associated to the processing module (21, 23, M, S; IP) which is provided for transmitting data to the network (NOC) and for receiving data from the network (NoC);
wherein the data transmission between processing modules (21, 23, M, S; IP) is based on time division multiple access using time slots (S₁-S₂₀) and on transmission by use of connections (C_{N});
wherein each network interface (NI) includes a slot table (54) for storing an allocation of a time slot to a connection (C_{N}), and
wherein multiple connections (C1-C4) are provided between a first processing module (21, M, IP) and a second processing module (23, S, IP) and a sharing of at least a part of time slots allocated to the multiple connections between the first and a second processing modules (21, 23, M, S; IP) is provided.
